(19) United States
(12) Patent Application Publication
(10) Pub. No.: US 2006/0148652 A1
(43) Pub. Date: Jul. 6, 2006

(54) Production of microbeads of pesticides and use of said microbeads for the protection of crops

(76) Inventors: Marie Van-Denabeele, Irigny (FR); Pierre Josselin, Saint Marcel (FR); Gerard Bornet, Vernon (FR); Gerard Joncheray, Vernon (FR); Kathelyne Everaere, Vernon (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/543,266

(22) PCT Filed: Feb. 3, 2004
(86) PCT No.: PCT/FR04/00239

§ 371 Date: Mar. 13, 2006

(30) Foreign Application Priority Data
Feb. 7, 2003 (FR) 0301457

(51) Int. Cl. A01N 25/28; A01N 25/00

(52) U.S. Cl. 504/359; 424/405

(57) ABSTRACT

Process for the manufacture of microbeads of an at least partially water-soluble pesticide by polycondensation of complementary organic reagents R¹ and R² in a liquid two-phase system, the reagent(s) R¹ being placed with the pesticide in a polar liquid phase (ωₚ) and the reagent(s) R² being placed in an oily liquid phase (ωₒ) comprising a solvent (S) that is immiscible with the polar phase and at least one surfactant for dispersing the polar phase (ωₚ) in the said oily phase (ωₒ) with stirring, characterized in that the pair of reagents R¹ and R² is chosen in such a way that the polycondensation occurs in the polar liquid phase (ωₚ).

The present invention concerns the field of plant protection and relates more particularly to the manufacture of microbeads impregnated with a partially water-soluble pesticide, such as methomyl, and to the use of these microbeads for protecting crops.

The microencapsulation of water-insoluble plant-protection active materials is a long-standing technique. The term “microencapsulation” means the enclosing of an active material that is liquid, or that has been made liquid by adding a solvent, inside a hollow microcapsule known as a “reservoir capsule” which thus consists of a liquid core and a solid hollow body similar to a tiny balloon filled with this liquid, or alternatively the enclosing of an active material inside a solid microbead which it then totally impregnates.

In the field of plant protection, microencapsulation is mostly applied to insecticidal active materials, although active materials for other biological purposes have also occasionally been microencapsulated. It involves giving extremely toxic and harmful active materials, by means of an astute formulation, a reduced toxicity which removes any major risk to the user, and a certain level of persistence which allows the treatment frequencies to be appreciably reduced.

The process that is most widely known is unquestionably microencapsulation by interfacial polymerization using an oil-in-water emulsion (patent U.S. Pat. No. 3,577,515). Several commercial products are currently manufactured on this principle by various plant protection companies. Numerous variants and improvements have been made to the abovementioned patent process, but they all come up against the same limitation: only water-insoluble active materials can be successfully microencapsulated by this technique.

The microencapsulation of totally or partially water-soluble active materials has been the subject of many patents, but patents relating to the field of plant-protection active materials are rare; nevertheless, mention may be made of patent EP 0 148 169 relating to the microencapsulation of glyphosate and a number of patents regarding the microencapsulation of methomyl (GB 2 027 346, EP 4758, U.S. Pat. No. 4,235,872, U.S. Pat. No. 4,282,209, U.S. Pat. No. 4,722,838). However, there is at the present time no commercial product consisting of a suspension of microcapsules or microbeads of a water-soluble or partially water-soluble plant-protection active material.

A typical example of a partially water-soluble plant-protection active material is methomyl, an insecticide of the carbamate family currently marketed as an aqueous-alcoholic solution under the name Lannate® 20L by the company E.I. du Pont de Nemours & Co. Methomyl currently occupies an essential position among insecticidal preparations intended for treating cotton plants. It moreover allows the control of many varieties of insects (especially lepidoptera, hemiptera, diptera and coleoptera) and red spiders (or mites) in orchard, vine, olive, hop, ornamental vegetable, curcurbit, flax, tobacco, soybean sprout, etc. crops. It is also used for controlling flying insects in poultry houses and breeding buildings.

Methomyl, which is a highly toxic active material, acts in a laminar manner on the plant and thus has systemic action. It is renowned for its knockdown effect, but its efficacy is short-lived, especially since methomyl becomes degraded when it is exposed to solar UV rays. Although its solubility in water is low, it is not negligible (58 g/l at 20° C.) and this level of solubility prevents methomyl from being encapsulated via the standard route (“oil-in-water” process of patent U.S. Pat. No. 3,577,515) since some of the methomyl diffuses out of the capsules until the maximum solubility of this active material in the water is reached.

It has now been found that, by polycondensation of a pair of complementary organic reagents placed in a first and a second immiscible liquid phase, it is possible to encapsulate the droplets of the first liquid containing dissolved methomyl (or any other at least partially water-soluble pesticide) in microbeads resulting from the polycondensate formed and thus to obtain microbeads containing methomyl (or other at least partially water-soluble pesticide) that do not have a tendency to aggregate or coalesce together. Since the liquid phase in which the microbeads are obtained is not a solvent for the methomyl (or other pesticide), it ensures that the active material is maintained in the microbeads for as long as is necessary.

A first subject of the present invention is thus a process for the manufacture of microbeads of an at least partially water-soluble pesticide by polycondensation of complementary organic reagents R¹ and R² in a liquid two-phase system, the reagent(s) R¹ being placed with the pesticide in a polar liquid phase (ωₚ) and the reagent(s) R² being placed in an oily liquid phase (ωₒ) comprising a solvent (S) that is immiscible with the polar phase and at least one surfactant for dispersing the polar phase (ωₚ) in the said oily phase (ωₒ) with stirring, characterized in that the pair of reagents R¹ and R² is chosen in such a way that the polycondensation occurs in the polar liquid phase (ωₚ).

A subject of the invention is also suspensions of microbeads impregnated with an at least partially water-soluble pesticide, especially methomyl, which are directly obtained by the process according to the invention or after an additional concentration operation.

A subject of the invention is also the use of the microbead suspensions according to the invention for the preparation of pesticidal formulations, in particular insecticidal formulations.

Although the process according to the invention is more particularly directed towards the microencapsulation of methomyl microbeads, it may be applied to any at least partially water-soluble pesticide, i.e. to any pesticide whose solubility in water at 25° C. is greater than or equal to 1 g/l. Examples of such pesticides that may be mentioned more particularly include glyphosate and aminotriazole.

Instead of using the active material itself, a solution of this active material in a polar solvent or a mixture of such solvents may be used; thus, for example, in the case of methomyl, Lannate® 20L may be used directly as polar phase.

The polycondensate according to the invention may be chosen from the group comprising polyamides, polysulphonamides, polycarbonates, polyesters, polyurethanes and polyureas, and is preferably a polyurethane or a polyurea.

In the first liquid phase (ωₚ), known as the “polar phase”, the solvent may be water or a polar solvent such as methanol, ethanol, dimethyl sulphoxide, N-methylpyrrolidone, dibasic esters (DBE) or a mixture of these compounds with each other and/or with water, preferably methanol alone or mixed with water.

The solvent (S) of the second liquid phase (ωₒ), known as the “oily phase”, is advantageously a plant or mineral oil, preferably an aliphatic oil containing little or no aromatic compounds, and more particularly a non-aromatic white oil.

The two liquid phases are such that they are immiscible and that the presence of one or more suitable surfactants in the oily phase allows, by a stirring means of any nature, the formation of an emulsion in which the polar phase is dispersed in the form of droplets (dispersed phase) in the oily phase (continuous or dispersing phase). The pair of reagents R¹ and R² is selected such that the solubility of reagent(s) R² in the polar liquid phase (ωₚ) is greater than the solubility of reagent(s) R¹ in the solvent (S). The reagent(s) R² migrate(s) from the oily phase into the droplets consisting of the dispersed polar phase at a migration rate such that the polycondensation takes place in solution in the droplets and leads to the formation of microbeads of polycondensate impregnated with the polar phase and with the pesticide it contains, for example methomyl.

One preferred embodiment of the process according to the invention consists:
(a) in preparing a polar liquid phase (ωₚ) by mixing the pesticide and the reagent(s) R¹ in water and/or a polar solvent, and then
(b) in dispersing this polar liquid phase (ωₚ) in an oily solution (ωₒ₁) of the surfactant(s) in the solvent (S) that is immiscible with the polar phase, with stirring, and
(c) in introducing into the stirred dispersion an oily solution (ωₒ₂) of the reagent(s) R², thus bringing about the polycondensation.

In certain cases, especially when the reagents R¹ and R² are introduced in proportions close to the stoichiometry (expressed as the number of moles of reactive functions), it is not necessary to use two oily solutions, (ωₒ₁) and (ωₒ₂) to make the oily phase (ωₒ) and it suffices to disperse, with stirring, the polar liquid-phase (ωₚ) from step (a) in a single oily phase (ωₒ) obtained by mixing the surfactant(s) and the reagent(s) R² in the solvent (S) that is immiscible with the polar phase.

The particular polycondensation according to the invention is made possible by means of an astute choice of the reagent(s) R¹ and R² placed in the dispersed polar phase and in the oily phase, respectively. The solubility of the reagents R¹ in the polar phase must be excellent. The reagents R² used must have good solubility in the oily phase, and, in accordance with the present invention, their solubility in the polar liquid phase is greater than the solubility of the reagents R¹ in the solvent(s). Since the rate of reaction between reagents R¹ and R² is low in relation to the migration rate of R² into the polar phase, these said reagents R² diffuse into the polar phase droplets and polycondense therein with the reagents R¹ dissolved in the droplet, the result of this being the formation of a polycondensate microbead impregnated with the polar phase and with the pesticide it contains, for example methomyl. A suspension of microbeads in the solvent (S) is thus obtained.

Among the pairs of reagents R¹ and R² that may be used in the microbead manufacturing process according to the invention, mention may be made more particularly of:
diamines and/or polyamines in one of the phases, and diisocyanates and/or polyisocyanates in the other phase, the resulting microbeads then being made of polyurea;
diols and/or polyols in one of the phases, and diisocyanates and/or polyisocyanates in the other phase, the resulting microbeads then being made of polyurethane;
diamines and/or polyamines in one of the phases, and diacid chlorides and/or polyacid chlorides in the other phase, the resulting microbeads then being made of polyamide;
diols and/or polyols in one of the phases, and diacid chlorides and/or polyacid chlorides in the other phase, the resulting microbeads then being made of polyester;
diamines and/or polyamines in one of the phases, and disulphonyl chlorides and/or polysulphonyl chlorides in the other phase, the resulting microbeads then being made of polysulphonamide.

Although this is not essential, it is preferred to work with pairs of reagents R¹ and R² at least one of which comprises more than two reactive functions.

It would not constitute a departure from the context of the present invention to use a mixture of reagents R¹ of different types and/or a mixture of reagents R² of different types. Thus, for example, polyurethane-polyurea microbeads will be formed by using an amine/alcohol mixture in combination with isocyanates.

In the context of the present invention, any diamine or polyamine capable of polycondensing with a diisocyanate or polyisocyanate, with a diacid chloride or polyacid chloride or with a disulphonyl chloride or polysulphonyl chloride to form a polyurea, a polyamide or a polysulphonamide, respectively, may be used. As non-limiting examples of diamines or polyamines that are suitable for the process according to the invention, mention may be made of ethylenediamine, diaminopropanes, diaminobutanes, hexamethylenediamine, diethylenetriamine, tris(2-aminoethyl)amine, 2,4,6-triaminopyrimidine, piperazine, tetraethylenepentamine, oxyalkylated diamines and polyamines such as those known under the name Jeffamine® from the company Huntsman Corporation or under the name PC Amine DA from the company Nitroil, especially the polyoxypropylenediamines Jeffamine® D-230 and Jeffamine® D-400 or the homologues thereof PC Amine DA 250 and PC Amine DA 400, the polyethylene glycol diamines Jeffamine® 600 and Jeffamine® 900, the triethylene glycol diamine Jeffamine® EDR-148 and the polyoxypropylenetriamine Jeffamine® T-403.

As non-limiting examples of diols or polyols that may be polycondensed with a diisocyanate or polyisocyanate or with a diacid chloride or polyacid chloride to form a polyurethane or a polyester, mention may be made of butanediols, pentanediols, 2-ethylhexanediol, diethylene glycol or triethylene glycol, dipropylene glycol or tripropylene glycol, pentaerythritol, trimethylolpropane and pyrogallol.

As non-limiting examples of diisocyanates or polyisocyanates that are suitable for the process according to the invention, mention may be made of hexamethylene diisocyanate, isophorone diisocyanate, dicyclohexylmethane diusocyanate, aliphatic polyisocyanate based on isophorone diisocyanate (Desmodur® Z 4470 SN from the company Bayer) and aliphatic polyisocyanates based on hexamethylene diisocyanate (Desmodur® N100, Desmodur N3200 and Desmodur® N3300 from the company Bayer).

As non-limiting examples of diacid chlorides or polyacid chlorides, mention may be made of sebacoyl chloride, terephthaloyl chloride, adipoyl chloride and trimesoyl chloride.

As non-limiting examples of disulphonyl chlorides or polysulphonyl chlorides, mention may be made of benzene-1,3-disulphonyl chloride and benzene-1,3,5-trisulphonyl chloride.

One of the advantages of the process according to the invention is that it allows the use of reagents that are extremely varied, in their chemical nature or, for the same family of compounds, in their chemical structure, and that they may be placed as desired in one or other of the liquid phases as appears to be the most appropriate, the simplest or the least expensive. The solubility of the various potential reagents in one and the other of the two phases is an important criterion in the choice of reagents and in the definition of the phase that will receive them. Thus, for example, if it is desired to manufacture polyurea microbeads, one or more diisocyanates or polyisocyanates will be used, and will be reacted with one or more diamines or polyamines; to do this, it is possible to work in a system in which the diamines and/or polyamines are dissolved in the polar phase, the diisocyanates and/or polyisocyanates themselves being dissolved in the oily phase, or to work in a system in which the diisocyanates and/or polyisocyanates are dissolved in the polar phase (which is necessarily free of water in this case), the diamines and/or polyamines themselves being dissolved in the oily phase.

In the first case (diamines and/or polyamines dissolved in the polar phase), diamines or polyamines such as polyoxypropylenediamines (for example the products Jeffamine® D-230, Jeffamine® D-400, PC Amine DA 250 and PC Amine DA 400) and hexamethylenediamine, or alternatively aromatic diamines or polyamines such as 2,4,6-triaminopyrimidine, will be selected. Aliphatic diisocyanates or polyisocyanates that are soluble or dilutable in the oily phase, whereas aromatic diisocyanates or polyisocyanates would be strictly insoluble therein, will moreover be selected.

In the second case (diamines and/or polyamines dissolved in the oily phase), the diisocyanates and/or polyisocyanates may be chosen from aliphatic compounds, whereas the diamines and/or polyamines will be, for example, ethylenediamine, diethylenetriamine or diamines and/or polyamines such as the Jeffamine® products.

It is thus possible, in the process according to the invention, to invert the place of residence of reagents belonging, respectively, to two given distinct chemical families, and this applies in particular when working on polycondensates of polyurea type.

When the polar phase contains an organic solvent mixed with water, it is possible not to put any reagent R¹ into the polar phase and to form polyurea microbeads by using diisocyanates and/or polyisocyanates introduced into the oily phase. Specifically, once these compounds have penetrated into the droplets of polar phase, some of their isocyanate functions undergo a hydrolysis reaction, the effect of which is to release carbon dioxide and to form amine functions constituting in situ the reagent R¹, which are then capable of reacting with the isocyanate functions still present, to give a polyurea. This in situ polycondensation system may be used alone or in combination with the polycondensation process described previously and leading to the formation of polyurea in the presence of diamines and/or polyamines in the polar phase and of diisocyanates and/or polyisocyanates in the oily phase, or of polyurethane in the presence of diols and/or polyols in the polar phase and of diisocyanates and/or polyisocyanates in the oily phase, the proportion of each type of reaction being governed by the respective proportions of reagents in each of the phases.

Since diols and polyols are less reactive than diamines and polyamines, it may prove necessary, for the manufacture of polyurethane microbeads, to introduce into one of the phases a common catalyst known to promote polycondensation, such as, for example, diazabicyclo[2.2.2]octane.

The mass ratio of the polar phase (ωₚ) to the oily phase (ωₒ) may range between 10/90 and 70/30.

The molar ratio between the functions of the reagents R¹ and R² introduced into the polar phase and into the oily phase, respectively, can range from 1/100 to 10/1; it is preferably between 1/20 and 3/1.

The mass proportion of polycondensate in the microbead is generally between 10% and 90%.

The mass proportion of pesticide that may be encapsulated by the process according to the present invention may vary within a wide range; in the case of methomyl, it may range from 1% to 27%.

Under certain conditions, and especially when it is desired to prepare a formulation containing a small proportion of polymer in the microbead and/or a large proportion of methomyl, it may be judicious to introduce into the polar phase a water-soluble salt such as, for example, sodium thiocyanate, potassium thiocyanate, sodium acetate or sodium chloride, preferably sodium thiocyanate. A mineral acid such as, for example, hydrochloric acid (HCl), hydrobromic acid (HBr) or hydroiodic-acid (HI) may also be added to the polar phase containing the water-soluble salt or not containing it, in order to facilitate, where appropriate, the subsequent transfer of the oily microbead suspension into aqueous emulsion.

In order to disperse the polar phase in the oily continuous phase, anionic or nonionic surfactants will be chosen, alone or as a mixture, such that the resulting HLB is suitable for the formation of the dispersion (HLB generally of between 1.8 and 8). The surfactants that may be used to obtain the desired HLB may be chosen more particularly from sorbitan esters and ethoxylated derivatives thereof, such as those sold by the company Witco under the names Sorban® and Sorbanox® or by the company Uniqema under the names Span® and Tween®, ethoxylated fatty alcohols, such as those sold by the company Uniqema under the name Synperonic®, alkylated poly(vinylpyrrolidones) such as those sold by the company ISP Investments under the name Agrimer® AL, and block copolymers such as those sold by the company Uniqema under the names Hypermer® and Atlox®.

The amount of surfactant or of the mixture of surfactants may vary within a wide range depending on all the various parameters of the reaction system. This amount generally ranges from 1% to 15% by weight of the formulation.

The size of the dispersed droplets results from all the parameters set in the process, especially the proportion of each of the phases, the quality and quantity of the surfactant(s), the temperature and the stirring speed. Examination under an optical microscope shows that the microbeads are spherical and well individualized. The final diameter of the microbeads, which is also governed by this set of parameters, may range up to 50 μm and is preferably between 0.5 and 20 μm. Analysis by laser granulometry in oil phase shows that the size distribution is of gaussian type.

The temperature at which the manufacture of the microbead suspension is performed is generally room temperature, but it is possible to work at a higher temperature (up to 65° C.) depending on the nature of the surfactants used to prepare the dispersion. It is also possible to modify the temperature in the course of the process, for example by peforming the dispersion at room temperature and then conducting the polycondensation at a higher temperature, which has the effect of accelerating the polycondensation reaction.

Provided that it does not lead to deterioration of the microbeads formed or in the course of formation (breaking, grinding, deformation, etc.), any mechanical stirring system may be suitable for achieving the dispersion and then the polycondensation resulting in the manufacture of the microbead suspension. However, but only for the dispersion operation (step b), another stirring system may be used, for example a rapid cage disperser of the Ultraturrax® type from the company IKA.

When the polar phase comprises methanol, alone or mixed with water, the reaction must be performed under conditions allowing the total evaporation of the methanol during the manufacture of the microbead suspension, and it may be judicious, in this case, to accelerate the process by heating the mixture to a suitable temperature. This system is particularly suitable for manufacturing dispersions that are highly concentrated (20% to 27%) in methomyl.

It is not essential to add at any time at all a dispersant to prevent and hinder the coalescence and aggregation of the microbeads formed during the process according to the invention. Nevertheless, the incorporation of such an agent is possible and, in this case, the finely divided solid compounds described in patent U.S. Pat. No. 3,575,882 may be used, for example.

The microbead suspension obtained in accordance with the process according to the invention may be used in unmodified form for protecting crops or for preparing various formulations that are useful for protecting crops. If so desired, the microbead suspension may be subjected to a washing operation in order to remove the impurities and the pesticide that has not been encapsulated in the microbeads. The suspension may also be filtered, this operation possibly being preceded or followed by a washing operation.

If so desired, one or more thickeners such as, for example, clays or silicas may be added to the microbead suspension, to obtain a slightly viscous, fluid and readily manipulable formulation, which is stable over time. An anti-sedimentation agent and/or an anti-aggregation agent and/or an antimicrobial agent may also be added to the suspension.

According to the desired application mode, the microbead suspensions according to the invention may be used:
as they are (without predilution);
diluted in an oil or any other support that may be used for treatments of low volume, very low volume , thermonebulization or aerosol type;
re-emulsified in water, this re-emulsification taking place using one or more surfactants introduced into the water before the suspension or alternatively into the suspension itself before it is mixed with the re-emulsification water.

The surfactant(s) may also be incorporated into the microbead suspensions before loading in drums in order to produce ready-to-use formulations that may be used with or without re-emulsification. Such a formulation may advantageously be packaged in water-soluble packaging.

### EXAMPLES

The following commercial products were used to perform the examples below, which illustrate the invention without limiting it:
Agrimer® AL 22=poly(vinylpyrrolidone) alkylated with hexadecene (VP/C₁₆H₃₂ weight ratio=20/80), of molar mass equal to 3130±40, known under the CAS number 63232-81-0 and sold by ISP Investments, Inc.
Desmodur® Z 4470 SN=aliphatic polyisocyanate based on isophorone diisocyanate (IPDI) sold by the company Bayer, with a molar mass equal to about 667 and with an NCO content equal to 11.9±0.4% (DIN standard EN ISO 11909)
Hypermer® E 476.=polymeric nonionic surfactant sold by the company Uniqema
Jeffamine® 400=polyoxypropylenediamine of structure:
   H₂N—CH(CH₃)—CH₂—[O—CH₂—CH(CH₃)]ₓ—NH₂ with x=5.6 known under the CAS number 9046-10-0 and sold by the company Huntsman Corporation
Marcol® 52=medicinal white oil sold by the company Esso (density at 20° C.: 825-845 kg/m³; kinematic viscosity at 40° C.: 7-8 mm²/s; FDA classification: a)
90 Neutral oil=liquid paraffin sold by the company Mobil Oil (density at 15° C.: 820-835 kg/m³; kinematic viscosity at 100° C.: 3.8-4.2 mm²/s)

### Example 1

### A. Preparation of Each of the Phases

Polar phase: 10.2 g of methanol, 4 g of 0.72% hydrochloric acid, 1.6 g of Jeffamine® 400, 0.46 g of 2,4,6-triaminopyrimidine (TAP) and 3.80 g of methomyl are mixed together in a 50 ml beaker and the phase is homogenized with magnetic stirring.
Oily phase 1: 45.28 g of 90 Neutral oil and 3.80 g of alkylated poly(vinylpyrrolidone) Agrimer® AL 22 are mixed together in a 400 ml beaker and the phase is homogenized.
Oily phase 2: 7.24 g of 90 Neutral oil, 3.4 g of alkylated poly(vinylpyrrolidone) Agrimer® AL 22, 27.44 g of isophorone diisocyanate (IPDI) and 5.88 g of polyisocyanate Desmodur® Z 4470 SN are placed in a 100 ml beaker and the phase is homogenized.
   Solubilities
The solubility of R² (mixture of IPDI and Desmodur® z 4470 SN) is of the order of 1 to 5% by weight in the polar phase.
The solubility of R¹ (mixture of Jeffamine® 400 and TAP) is of the order of 0% by weight in the solvent (S).

### B. Dispersion Followed By Encapsulation

The polar phase is poured into the oily phase 1 with mechanical stirring at a speed of about 1000 rpm. A dispersion is formed very rapidly and, after stirring for 8 to 10 minutes and with continued stirring, the oily phase 2 is poured into the dispersion. The reaction is allowed to proceed until the polymerization is complete and all the methanol evaporated. 10% by weight of an oily 10% bentone solution is then added to the microbead suspension obtained, with vigorous stirring.

An oily suspension of methomyl microbeads which is stable over time is obtained. Examination using a scanning electron microscope equipped with a cryogenic system shows that the particles are solid and homogeneous in their bulk; no differentiated wall is visible. The methomyl is also distributed throughout the microbeads. This suspension (referred to as Suspension No. 1 hereinbelow) has the following characteristics:
methomyl content: 3.3% by weight
polymer content in the microbeads: 82.0% by weight
mean diameter of the microbeads: 5-9 μm

### Example 2

### A. Preparation of Each of the Phases

Polar phase: 20.2 g of methanol, 4 g of water, 1.6 g of Jeffamine® 400, 0.46 g of 2,4,6-triaminopyrimidine (TAP), 4 g of sodium thiocyanate and 18 g of methomyl are mixed together in a 50 ml beaker and the phase is homogenized with magnetic stirring.
Oily phase 1: 31.28 g of 90 Neutral oil and 3.60 g of alkylated poly(vinylpyrrolidone) Agrimer® AL 22 are mixed together in a 400 ml beaker and the phase is homogenized.
Oily phase 2: 5.49 g of isophorone diisocyanate (IPDI) and then 1.18 g of polyisocyanate Desmodur® Z 4470 SN, are placed in a 100 ml beaker and the phase is homogenized.
   Solubilities
The solubility of R² (mixture of IPDI and Desmodur® Z 4470 SN) is of the order of 1 to 5% by weight in the polar phase.
The solubility of R¹ (mixture of Jeffamine® 400 and TAP) is of the order of 0% by weight in the solvent (S).

### B. Dispersion Followed By Encapsulation

The polar phase is poured into the oily phase 1 with mechanical stirring at a speed of about 800 rpm. A dispersion forms very quickly and, after stirring for 5 minutes and with continued stirring, the oily phase 2 is poured into the dispersion. The reaction is allowed to proceed until the polymerization is complete and all the methanol evaporated. 10% by weight of an oily 10% bentone solution is then added to the microbead suspension obtained, with vigorous stirring.

An oily suspension of methomyl microbeads which is stable over time is obtained. This suspension (referred to as Suspension No. 2 hereinbelow) has the following characteristics:
methomyl content: 23.3% by weight
polymer content in the microbeads: 25.1% by weight
mean diameter of the microbeads: 1-2 μm

Instead of successively introducing the oily phases 1 and 2, the reaction may be performed under excellent conditions by initially mixing together the oily phases 1 and 2, followed by adding the polar phase to the phase thus obtained. An oily suspension of methomyl microbeads which is stable over time is again obtained.

### Example 3

### A. Preparation of Each of the Phases

Polar phase: 14.2 g of methanol, 1.6 g of Jeffamine® 400, 0.46 g of 2,4,6-triaminopyrimidine (TAP), 3 g of sodium thiocyanate and 12 g of methomyl are mixed together in a 50 ml beaker and the phase is homogenized with magnetic stirring.
Oily phase 1: 30 g of Marcol® 52 oil and 3.6 g of alkylated poly(vinylpyrrolidone) Agrimer® AL 22 are mixed together in a 400 ml beaker and the phase is homogenized.
Oily phase 2: 2.74 g of isophorone diisocyanate (IPDI) and then 0.59 g of polyisocyanate Desmodur® Z 4470 SN are placed in a 100 ml beaker and the phase is homogenized.
   Solubilities
The solubility of R² (mixture of IPDI and Desmodur® Z 4470 SN) is of the order of 1 to 5% by weight in the polar phase.
The solubility of R¹ (mixture of Jeffamine® 400 and TAP) is of the order of 0% by weight in the solvent (S).

### B. Dispersion Followed By Encapsulation

The polar phase is poured into the oily phase 1 with mechanical stirring at a speed of about 700 rpm. A dispersion forms very quickly and, after stirring for 3 to 5 minutes and with continued stirring, the oily phase 2 is poured into the dispersion. The reaction is allowed to proceed until the polymerization is complete and all the methanol evaporated. 10% by weight of an oily 10% bentone solution is then added to the microbead suspension obtained, with vigorous stirring.

The reaction may also be performed under excellent conditions by initially mixing together the oily phases 1 and 2, followed by adding the polar phase to the phase thus obtained.

In either case, an oily suspension of methomyl microbeads which is stable over time and which has the following characteristics is obtained:
methomyl content: 20.0% by weight.
polymer content in the microbeads: 26.4% by weight
mean diameter of the microbeads: 0.5-1 μm

### Example 4

### A. Preparation of Each of the Phases

Polar phase: 14.2 g of dimethyl sulphoxide, 1.6 g of Jeffamine® 400, 0.46 g of 2,4,6-triaminopyrimidine (TAP), 1 g of sodium thiocyanate and 12 g of methomyl are mixed together in a 50 ml beaker and the phase is homogenized with magnetic stirring.
Oily phase 1: 32 g of Marcol® 52 oil and 2.5 g of Hypermer® E 476 are mixed together in a 400 ml beaker and the phase is homogenized.
Oily phase 2: 10.98 g of isophorone diisocyanate (IPDI) and then 2.36 g of polyisocyanate Desmodur® Z 4470 SN are placed in a 100 ml beaker and the phase is homogenized.
   Solubilities
The solubility of R² (mixture of IPDI and Desmodur® Z 4470 SN) is of the order of 100% by weight in the polar phase.
The solubility of R¹ (mixture of Jeffamine® 400 and TAP) is of the order of 0% by weight in the solvent (S).

### B. Dispersion Followed By Encapsulation

The polar phase is poured into the oily phase 1with mechanical stirring at a speed of about 850 rpm. A dispersion forms very quickly and, after stirring for 10 minutes and with continued stirring, the oily phase 2 is poured into the dispersion. The reaction is allowed to proceed until the polymerization is complete, and 10% by weight of an oily 10% bentone solution is then added to the microbead suspension thus obtained, with vigorous stirring.

The reaction may also be performed under excellent conditions by initially mixing together the oily phases 1 and 2, followed by adding the polar phase to the phase thus obtained.

In either case, an oily suspension of methomyl microbeads which is stable over time and which has the following characteristics is obtained:
methomyl content: 14.0% by weight
polymer content in the microbeads: 36.2% by weight
mean diameter of the microbeads: 3-5 μm

If, in Examples 1 to 4, the Jeffamine® 400 is replaced with PC Amine DA 400 sold by the company Arnaud Promecome, exactly the same microbead suspensions are obtained.

### Example 5

### A. Preparation of Each of the Phases

Polar phase: 18.5 g of DMSO, 13.5 g of butyl glycol, 2 g of water, 2.4 g of sodium thiocyanate, 13.5 g of methomyl and 0.05 g of diazabicyclo[2.2.2]octane are mixed together in a 100 ml beaker and the phase is homogenized with magnetic stirring.
Oily phase 1: 50 g of Marcol® 52 oil and 3 g of alkylated poly(vinylpyrrolidone) Agrimer® AL 22 are mixed together in a 400 ml beaker and the phase is homogenized.
Oily phase 2: 6.8 g of hexamethylene diisocyanate (HMDI) are placed in a 10 ml beaker.
   Solubilities
The solubility of R² (HMDI) is of the order of 100% by weight in the polar phase.
The solubility of R¹ (butyl glycol) is of the order of 60% by weight in the solvent (S).

### B. Dispersion Followed By Encapsulation

The polar phase is poured into the oily phase 1 with mechanical stirring at a speed of about 700 rpm. A dispersion forms very quickly and, after stirring for 2 to 3 minutes and with continued stirring, the oily phase 2 is poured into the dispersion. The reaction is allowed to proceed until the polymerization is complete. 10% by weight of an oily 10% bentone solution is then added to the microbead suspension obtained, with vigorous stirring.

An oily suspension of methomyl microbeads which is stable over time and which has the following characteristics is obtained:
methomyl content: 11.1% by weight
polymer content in the microbeads: 12.0% by weight
mean diameter of the microbeads: 8-10 μm

### Example 6

### Use of the Methomyl Microbead Suspensions

The value and the biological efficacy of the formulations based on methomyl microbead suspensions according to the invention were evaluated. The target chosen is a cabbage moth known as “Mamestra brassicae”. The cabbages are treated with slurries prepared from the methomyl microbead formulations. After drying, Mamestra brassicae caterpillars are placed on cabbage leaves which have been taken and placed in boxes. 24 hours and 48 hours after infestation, the number of live caterpillars is noted. Further infestations are performed daily on cabbage leaves taken as and when necessary. The duration of action and the efficacy of the various formulations may thus be evaluated, compared with an untreated control and a reference (in this instance Lannate® 20L).

The tests proceed in several phases according, to the methodology described below:
reception and treatment of the cabbages
reception and end of incubation of the caterpillars
daily infestations
assessments
analysis
   1. Treatment of the Cabbages

The cabbages are received and repotted in pots 11×11 cm in size such that they have about ten leaves at the start of the test. In the event of attack by cabbage-whites, an insecticidal treatment of low persistence may be performed at least 15 days before the start of the test.

For 10 infestations, 6 modes and 6 repetitions, 360 leaves are required, and, if 3 leaves taken per cabbage are counted, 120 cabbages are required.

The cabbages are treated in a spraying tower at a dose of 800 l/ha with a slurry which allows 60 to 200 g of methomyl to be applied per hectare.

This slurry is prepared as follows: ¼ of the amount of water required and a surfactant system for emulsifying the microbead suspension are placed in a measuring cylinder. This mixture is stirred and the adequate amount of the microbead suspension is then added, with vigorous stirring. The mixture is then completed with a sufficient amount of water and, if necessary, a few drops of antifoam are added. The level is adjusted to the exact volume and the slurry is stirred, and is then ready to be sprayed.

The Lannate® 20L slurry is prepared in the following manner: the desired amount of Lannate® 20L is placed in ¾ of the required amount of water, along with a wetting agent, and the mixture is then made up to the desired volume with water.

1. Reception of the Caterpillars

The caterpillars arrive in the form of eggs deposited on sheets of paper. On reception, these sheets are to be placed at 15° C. or at 25° C. according to the expected hatching date. The test is performed with caterpillars at the L1 stage, i.e. the infestations are performed on the day the caterpillars hatch.

1. The Infestations

The term “infestation” means the placing of the caterpillars in contact with the treated cabbage leaves. The infestation is performed in transparent boxes with a lid, 17.5×11.5×6.5 cm in size. Each box is a unit plot. One cabbage leaf is placed in a box and 8 caterpillars are placed on this leaf, using a brush. The boxes are arranged in a latin square in an air-conditioned room. The boxes are illuminated for 16 hours per day and the temperature inside them is maintained at 20° C.

The infestations take place daily, the first being performed on the actual day of treatment of the cabbages (D0) or the following day (D1) and the others 2 or 6 days after the treatment (infestations D2 and D6, respectively).

1. The Assessments

One observation is made 48 hours after the infestation. The number of live caterpillars in each box is then counted. After this assessment, the leaves and caterpillars are discarded and the boxes are washed.

1. Results

The tables below summarize the results of two biological tests performed in a greenhouse. After conversion of the data into log (x+1), an analysis of variance is performed. This is followed by a Newman-Keuls test, which allows the statistical classification of the various modes.

TABLE 1
Results of the first test

| | | Average number of live | | | | |
|---|---|---|---|---|---|---|
| | Dose of | caterpillars per box, 48 hours | | | | |
| | methomyl | after infestation | | | | |
| | per | Infestation | | Infestation | Infestation | |
| Product | hectare | D0 | | D2 | D6 | |
| None | — | 6.5 | a* | 7 | 5.5 | a* |
| (control) | | | | | | |
| Lannate ® | 200 g | 0 | b | 3.8 | 4 | a |
| 20L | | | | | | |
| Suspension | 200 g | 0 | b | 1 | 0.7 | b |
| No. 1 | | | | | | |
| Suspension | 60 g | 0.2 | b | 1.3 | 3.7 | a |
| No. 1 | | | | | | |
| Suspension | 60 g + 140 g | 0 | b | 1 | 0.7 | b |
| No. 1 + Suspension | | | | | | |
| No. 2 | | | | | | |

*statistical significance: the means that do not have common letters differ significantly at the 5% threshold

TABLE 2
Results of the second test

| | | Average number of live | | | | | |
|---|---|---|---|---|---|---|---|
| | Dose of | caterpillars per box, 48 hours | | | | | |
| | methomyl | after infestation | | | | | |
| | per | Infestation | | Infestation | | Infestation | |
| Product | hectare | D1 | | D2 | | D6 | |
| None | — | 8 | a* | 7.7 | a* | 7.8 | a* |
| (control) | | | | | | | |
| Lannate ® | 200 g | 0 | b | 3.2 | c | 7.8 | a |
| 20L | | | | | | | |
| Suspension | 200 g | 0.2 | b | 0 | d | 0.3 | d |
| No. 1 | | | | | | | |
| Suspension | 200 g | 0.5 | b | 4.7 | b | 6 | c |
| No. 2 | | | | | | | |
| Suspension | 140 g | 0.5 | b | 5.5 | ab | 6.3 | bc |
| No. 2 | | | | | | | |

*statistical significance: the means that do not have common letters differ significantly at the 5% threshold

The results of these tests show the value of Suspension No. 1 and of its combination with Suspension No. 2, both used at a dose of 200 g of methomyl per hectare. These formulations make it possible rapidly to obtain good insecticidal efficacy and excellent persistence of action.

1. Process for the manufacture of microbeads of an at least partially water-soluble pesticide by polycondensation of complementary organic reagents R¹ and R² in a liquid two-phase system, the reagent(s) R¹ being placed with the pesticide in a polar liquid phase (ωₚ) and the reagent(s) R² being placed in an oily liquid phase (ωₒ) comprising a solvent (S) that is immiscible with the polar phase and at least one surfactant for dispersing the polar phase (ωₚ) in the said oily phase (ωₒ) with stirring, characterized in that the pair of reagents R¹ and R² is chosen in such a way that the polycondensation occurs in the polar liquid phase (ωₚ).

2. Process according to claim 1, in which:
(a) the solubility of the reagent(s) R² in the polar liquid phase (ωₚ) is greater than the solubility of the reagent(s) R¹ in the solvent (S);
(b) the migration rate of the reagent(s) R² is such that the polycondensation occurs in the polar liquid phase (ωₚ).

3. Process according to claim 1, which comprises:
(a) preparing a polar liquid phase (ωₚ) by mixing the pesticide and the reagent(s) R¹ in water and/or a polar solvent, and then
(b) dispersing this polar liquid phase (ωₚ) in an oily solution (ωₒ₁) of the surfactant(s) in the solvent (S) that is immiscible with the polar phase, with stirring, and
(c) introducing into the stirred dispersion an oily solution (ωₒ₂) of the reagent(s) R², thus bringing about the polycondensation.

4. Process according to claim 1, in which the solvent (S) is a plant or mineral oil.

5. Process according to claim 1, in which the polar solvent is methanol, ethanol, dimethyl sulphoxide, N-methylpyrrolidone, dibasic esters (DBE) or a mixture of these compounds with each other and/or with water.

6. Process according to claim 1, in which the surfactant is an alkylated poly(vinylpyrrolidone).

7. Process according to claim 1, in which the reagents R¹ and R² are capable of forming a polycondensate chosen from polyamides, polysulphonamides, polycarbonates, polyesters, polyurethanes and polyureas.

8. Process according to claim 7, in which the polycondensate is a polyurea formed from a mixture R¹ of diamines and/or triamines in the polar phase and from a mixture R² of aliphatic diisocyanates and/or triisocyanates in the oily phase, at least one of the mixtures R¹ and R² comprises a trifunctional compound.

9. Process according to claim 1, in which the mass ratio of the polar phase to the oily phase ranges between 10/90 and 70/30.

10. Process according to claim 1, in which the molar ratio between the functions of the reagents R¹ and R² is between 10/1 and 1/100.

11. Process according to claim 1, in which the mass proportion of surfactant in the formulation is between 1% and 10%.

12. Process according to claim 1, in which the polar phase also contains a water-soluble salt.

13. Process according to claim 1, also comprising at least one concentration step.

14. Process according to claim 1, also comprising a step of adding a thickener and/or an anti-sedimentation agent and/or an anti-aggregation agent and/or an antimicrobial agent.

15. Process according to claim 1, in which the pesticide is an insecticide.

16. Suspension of microbeads of an at least partially water-soluble pesticide, obtained by a process according to claim 1.

17. Suspension according to claim 16, in which the mass content of pesticide is between 1% and 70%.

18. Suspension according to claim 16, in which the mass content of microbead polycondensate is between 10% and 90%.

19. Use of a suspension according to claim 16, for the preparation of pesticidal formulations.

20. Process according to claim 1 in which the solvent is an aliphatic oil.

21. Process according to claim 1 in which the solvent is non-aromatic oil.

22. Process according to claim 1 in which the polar solvent is methanol alone or mixed with water

23. Process according to claim 1, in which the surfactant is a poly(vinylpyrrolidone) alkylated with hexadecene.

24. Process according to claim 1, in which the reagents R¹ and R² are capable of forming a polycondensate chosen from a polyurethane or a polyurea.

25. Process according to claim 1 in which the molar ratio between the functions of the reagents R¹ and R² is between 3/1 and 1/20.

26. Process according to claim 1 in which the mass proportion of surfactant in the formulation is between 2% and 8%.

27. Process according to claim 1 in which the polar phase also contains sodium thiocyanate water-soluble salt.

28. Process according to claim 1 in which the pesticide is an insecticide, methomyl.

29. Process according to claim 1 in which the mass content of pesticide is between 1% and 30%.

30. Use of a suspension according to claim 1 for the preparation of insecticidal formulations.
